(19) United States
(12) Patent Application Publication
(10) Pub. No.: US 2022/0245551 A1
(43) Pub. Date: Aug. 4, 2022

(54) ADJUSTABLE WORK-FLOW CAPACITY PLANNING

(71) Applicant: ServiceTitan, Inc., Glendale, CA (US)

(72) Inventors: Miles Gordenker, Ventura, CA (US); HangKwai Pun, Los Angeles, CA (US); Nicholas Houser, Ypsilanti, MI (US); Ani Karakashian, Los Angeles, CA (US); Anna Singer, Los Angeles, CA (US)

(21) Appl. No.: 17/591,082

(22) Filed: Feb. 2, 2022

Related U.S. Application Data
(60) Provisional application No. 63/145,279, filed on Feb. 3, 2021.

(51) Int. Cl. G06Q 10/06

(52) U.S. Cl. CPC G06Q 10/06316; G06Q 10/063116; G06Q 10/0633

(57) ABSTRACT

Aspects of the present disclosure involve systems, methods, computer program products, and the like, for scheduling and assigning work to a plurality of workers or service technicians. Data identifying jobs, timeframes that respective jobs should be performed, and job locations may be compared to times when workers are available to work. Each of the workers may be assigned particular jobs to begin during specific timeframes. These assignments may be based on information that identifies time slots when each worker is available to work, an estimated amount of time that particular jobs should take, skills of particular workers, and estimated travel times between jobs. After specific workers have been identified to work on specific jobs, a scheduling computer may send messages to computing devices of respective workers to schedule or reschedule work. These messages may identify job locations and timeframes that each job should be performed or begun.

### CROSS-REFERENCE TO RELATED APPLICATIONS

The present application claims the benefit under 35 U.S.C. § 119(e) of U.S. Provisional Patent Application No. 63/145,279 filed Feb. 3, 2021, the entire contents of which are incorporated by reference herein.

### FIELD

The description relates to work scheduling. More specifically the description is directed to adjusting work schedules dynamically over time.

### BACKGROUND

Technicians deployed to particular jobs generate revenue from performing work at job sites. Commonly work is assigned to technicians after a customer has called a service provider. This process often includes assigning a window of time that work on a job should begin. For example, a customer may be told that a technician will arrive at their place of business or their home Tuesday between 9 am and 2 pm. A particular technician may then be assigned several jobs to perform or start between 9 am and 2 pm on Tuesday. The number of jobs that a technician is assigned during a timeframe or time slot may be based on an estimate or an average amount of time that it takes for jobs to be completed. So a first technician may be assigned three jobs to perform or start during a timeframe.

In such an instance, the technician may arrive at a first job site at 9 am and perform a job that takes 1.5 hours (9 am-10:30 am), drive to a second job site over 20 minutes (10:50 am), perform a second job that takes 2 hours (12:50 pm), drive for 30 minutes to a third job site (12:50 pm-120 pm), and begin working on the third job before 2 pm. If the first or the second job takes longer than the 1.5 or 2 hours, the first technician might not be able to make it to the third jobsite before 2 pm. As such, the first technician may not arrive in time to begin the third job during the timeframe promised to the customer. This can lead to customer being dissatisfied and can result in lost business.

When a company schedules the first technician to perform 3 jobs during the timeframe and schedules a second technician to perform 3 jobs during that timeframe, and the second technician completes his 3 jobs early, the second technician would be available to perform one of the jobs originally assigned to the first technician. Current work flow capacity planning methods have little or no facility for adjusting work between multiple different technicians. Furthermore, in such an instance, rescheduling work flow involves informing both technicians of the change to their work assignments. Such communications are problematic as such communications may only be performed after both technicians have been contacted about the rescheduled work. Technicians may not timely inform the company that they have completed or begun a job and it may be difficult to confirm that a technician has been sent or has received an updated work schedule. In certain instances, a supervisor may be distracted or may forget to contact a technician. Because of this and other reasons, communications between a company and technicians may not be efficient and a total amount of work performed and revenue earned may not be optimal because of communication delays or errors.

The problem mentioned above increases at best linearly and at worst geometrically with the number of technicians that a company has working for them. When a company has 10 technicians, delays and errors may be compounded by over 10 times. When a company has 100 technicians servicing an area, delays and errors may be compounded by more than 100 times.

Because of this, there is a need to collect information, make job assignments, collect additional information, and adjust those job assignments as conditions change dynamically over time. It is with these observations in mind, among others, that aspects of the present disclosure were concerned and developed.

### SUMMARY

Embodiments of the description generally relate to systems and methods for scheduling work after customers have called a service company and provided data about scheduling work. In some examples, a method for planning a work-flow capacity is provided. This method may include receiving by a capacity planning system data that identifies a first set of time frames, reviewing data that identifies a number of technician shifts, and receiving data that identifies a job. Next, a first technician and a first time slot to perform the job may be assigned. The assignment of the first technician and first time slot may be identified by performing a comparison that compares the first set of time frames with the data that identifies the number of technician shifts. This process may also include identifying based on the comparison, that the first technician can perform the job during the first time slot. The presently claimed method may also include sending an assignment message to an electronic device associated with the first technician. The message sent to the electronic device of the first technician may identify the job and the first time slot.

In some examples, a system is provided. The system comprises one or more processors, and a non-transitory computer-readable storage medium containing instructions which, when executed on the one or more processors, cause the one or more processors to perform operations including: receiving data that identifies a first set of time frames, reviewing data that identifies a number of technician shifts, receiving data that identifies a job, and assigning a first technician and a first time slot to perform the job. The assignment of the first technician and first time slot may be identified by comparing the first set of time frames with the data that identifies the number of technician shifts. This process may also include identifying based on the comparison, that the first technician can perform the job during the first time slot. The one or more processors may then execute further instructions that result in an assignment message being sent to an electronic device associated with the first technician. The message sent to the electronic device of the first technician may identify the job and the first time slot.

In yet another example, an apparatus that includes a communication interface may receive data that identifies a first set of time frames. This apparatus may include a processor that executes instructions out of a memory to review data that identifies a number of technician shifts and review data that identifies a job. The processor may also assign a first technician and a first time slot to perform the job. The first technician and the first time slot may have been identified by performing a first comparison that compares a first set of time frames with the data that identifies the number of technician shifts. Additional instructions may be executed by the processor to identify based on the first comparison that the first technician can perform the job during the first time slot. The communication interface at the apparatus may then be used to send a message to an electronic device associated with the first technician that identifies the job and the first time slot.

In some examples, methods or apparatus may include receiving an indication from the electronic device that the job has been performed within the first time slot, identifying a second job to assign to the first technician during the first time slot based on an amount of time remaining in the first time slot, and sending a second assignment message to the electronic device of the first technician that identifies the second job. These methods or apparatus may also evaluate data that identifies a third job that has been assigned to the first technician during the first time slot, identify that the second job cannot be started by the first technician during the first time slot, perform a second comparison that compares the first set of time frames with the data that identifies the number of technician shifts, identify based on the second comparison that a second technician can perform the job during the first time slot, and send a third assignment message to an electronic device of the second technician that identifies the third job and the first time slot. This may result in the second technician beginning the third job based on the third assignment message being sent to the electronic device of the second technician.

In some examples, methods or apparatus may receive a parameter that adjusts an availability of one or more technicians during the first set of time frames. Such a method may include assigning at least one of a busy status, a standby status, or an available status to each of the one or more technicians during the first set of frames. This may result in a second technician being assigned the standby status during a second time slot based on the received parameter. Methods consistent with the present disclosure may also include receiving data that identifies a second job and that identifies that the second job is scheduled to be begun during the second time slot. This method may also include identifying that none of the one or more technicians are assigned the available status during the second time slot, and sending a second assignment message to an electronic device of the second technician based on the second technician being assigned the standby status during the second time slot.

These exemplary methods or apparatus may also adjust the availability of the one or more technicians according to the parameter before assigning the at least one of the busy status, the standby status, or the available status to each of the one or more technicians. Such a parameter may identify a time associated with the one or more time frames that the one or more technicians will be assigned the standby status.

Alternatively, or additionally, exemplary methods and apparatus may identify a beginning time of a first technician work shift, this beginning time of the first technician work shift may occur within the first set of time frames. Furthermore, these methods or apparatus may identify a beginning time of a second technician work shift. The beginning time of the second technician work shift may be different from the beginning time of the first technician work shift, and the beginning time of the second technician work shift may occur within the first set of time frames.

### BRIEF DESCRIPTION OF THE DRAWINGS

The description will be more fully understood with reference to the following figures, which are presented as various embodiments of the disclosure and should not be construed as a complete recitation of the scope of the disclosure, wherein:

FIG. 1 is a block diagram that illustrates a series of steps where workers are assigned jobs dynamically over time.

FIGS. 2a-b illustrate additional sets of steps that may be performed when work flow is controlled dynamically, here however, parameters may be used allow additional work assignments to be added at time when working demands are expected to change unexpectedly.

FIG. 3 illustrates a set of steps that may be performed when specific job types are matched to the skills of particular workers.

FIG. 4 illustrates a system that may perform the functions of receiving job information, identifying available technicians, making job assignments, and sending those assignments to technician mobile devices.

FIG. 5 illustrates steps that may be performed by a technician mobile device during a work day of a particular technician.

FIG. 6 is a block diagram illustrating an example of a computing device or computer system 600 which may be used in implementing the embodiments of the components of the network disclosed above.

### DETAILED DESCRIPTION

Aspects of the present disclosure involve systems, methods, computer program products, and the like, for scheduling and assigning work to a plurality of workers or service technicians. Data identifying jobs, timeframes that respective jobs should be performed, and job locations may be compared to times when workers are available to work. Each of the workers may be assigned particular jobs to begin during specific timeframes. These assignments may be based on information that identifies time slots when each worker is available to work, an estimated amount of time that particular jobs should take, skills of particular workers, and estimated travel times between jobs. After specific workers have been identified to work on specific jobs, a scheduling computer may send messages to computing devices of respective workers to schedule or reschedule work. These messages may identify job locations and timeframes that each job should be performed or begun. These messages may also identify a type of job at each respective location. The scheduling computer may also receive messages from the worker computing devices that identify a status of different jobs and the scheduling computer may then send additional messages to the working computing devices to update work schedules of particular workers.

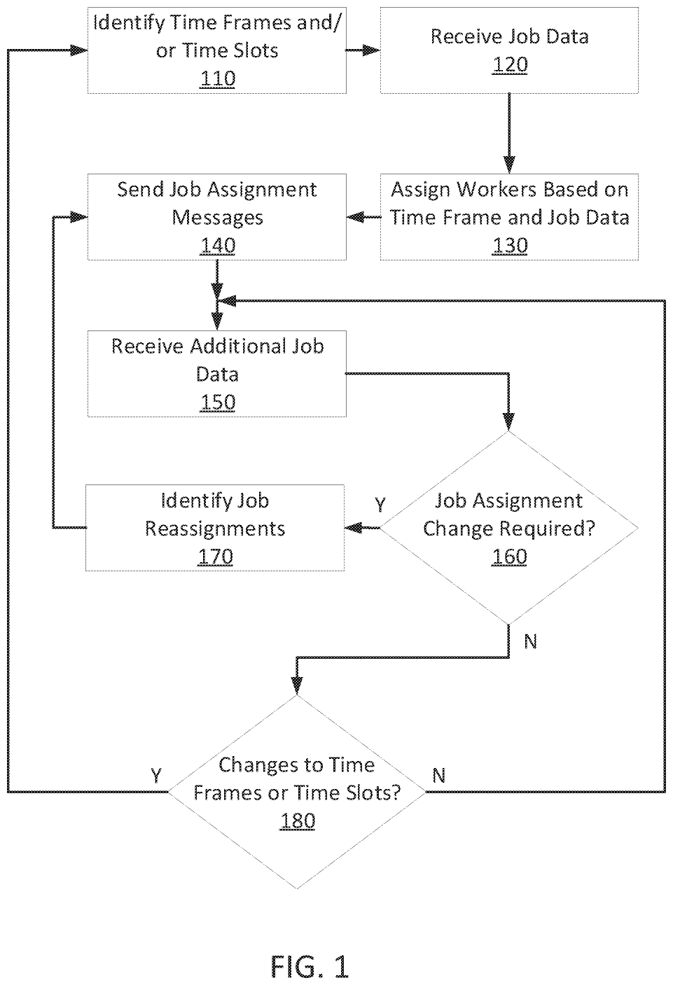

FIG. 1 is a block diagram that illustrates a series of steps where workers are assigned jobs dynamically over time. FIG. 1 begins with step 110 where one or more time frames and/or time slots are identified or received. Each of the time frames may correspond to a set of hours during a day where work at a customer site is scheduled to begin. Various different customers may be informed that a service technician will arrive at their home or business between 9 am and 2 pm perform a service. A particular service technician may also be scheduled to work during these time frames or service technicians may be assigned working time slots that do not completely overlap with a given timeframe. For example, technician Tom Smith may not be available to work at customer sites until after 10:30 am on a given day. This may mean that Tom Smith will not be available to be assigned to a job between 9 am to 10:29 am. Instead, Tom Smith would only be able to be assigned work during a time slot that spans from 10:30 am to 2 pm. As such, methods and systems consistent with the present disclosure may identify or receive both timeframe information and time slot information when generating work schedules.

Systems consistent with the present disclosure may be configured to include time slots that are offset from customer time frames for any reason. For example, Tom Smith may have a meeting with their supervisor or doctor at 9 am or Tom Smith may have some other appointment or activity that he must attend. In such instances, other technicians may be assigned to work at customer sites on that particular day beginning at 9 am. Systems and methods of the present disclosure may calculate or evaluate a number of work hours for each timeframe and this data may also be set according to need of tens, dozens, or hundreds of workers. Because of this, methods and systems consistent with the present disclosure may dynamically adjust which workers work on certain jobs to meet the needs of customers and the needs of workers in a way that could not be managed by humans alone.

After step 110, job data may be received at step 120 of FIG. 1. The job data received at step 120 may identify a type of job, a job location, and a timeframe that the customer expects a service technician to arrive at the job location. Next in step 130 of FIG. 1, workers may be assigned specific jobs during specific timeframes. Step 130 may include evaluating both the timeframe data, the job data, and may also include evaluating time slots that each particular worker is available to work. This step may identify workers that should be assigned certain specific jobs based on their skill set matching requirements of a job. As such, this process may also include comparing skills required to perform a particular job with skills of particular workers. Workers or technicians may only be assigned jobs for which they are qualified. More junior workers may be assigned certain tasks that they can perform without supervision or be assigned other jobs only when a supervisor is available to work with them.

After work assignments have been identifies in step 130, job assignment messages may be sent to individual worker devices at step 140. For example, a computer at a centralized work-flow capacity planning center performing the steps of FIG. 1 may send work assignment messages to dozens of workers after those assignments have been identified. This computer may also store an overall work schedule at a database as that computer tracks work-flow over time. These messages may be sent via any communication medium known in the art, for example, messages may be sent via cellular communications to cell phones, tablet computers, or other devices accessible by individual technicians.

Next, in step 150 additional job data may be received and evaluated, this evaluation may review whether any of the current job assignments need to be reassigned. Determination step 160 may then identify whether any of the current job assignments should be reassigned. Determination step 160 may identify that the additional job data includes a new job that is closer to a location where technician Jane Jones currently is located than a location where technician Tom Smith is currently located and this may result in Jane Jones being assigned this new job based on relative locations in step 170. This may also result in Tom Smith being assigned a next job that Jane Jones was previously assigned to in step 170. Messages may then be sent to mobile devices of both Jane Jones and to Tom Smith in step 140 of FIG. 1. The message sent to the mobile device of Jane Jones may instruct Jane that she should drive to a location associated with the new job and inform Jane that her other job has been reassigned to another technician. The message sent to the mobile device of Tom Smith, may include information identifying the reassigned job, its location, and this message may also identify the timeframe or time slot that this reassigned job has been assigned.

Job reassignments may be performed for any number of reasons, for example, a first technician may send a message to a dispatching capacity planning computer indicating that a particular job cannot be completed by him in time for him to move to a second job scheduled during a timeframe. This may cause a process at the dispatching capacity planning computer to execute instructions that identify an alternative technician that could be assigned the second job. Messages may then be sent to devices of the first technician and the alternative technician identifying the scheduled work changes in step 140. Other reasons that may be a basis for reassigning jobs may be made based on determinations that identify a change in transit time (e.g. because of excessive traffic or an accident), identify that a new job has been received, or some other factor.

When determination step 160 identifies that changes in job assignments are not required, program flow may move to determination step 180 that identifies whether a change to a timeframe or time slot has occurred. A timeframe may be changed based on a previously scheduled customer cancelling an appointment for service or may be changed when that customer both cancels an appointment and reschedules that appointment. A change in a time slot may occur when a particular technician becomes indisposed for some reason, for example: because of a delay, because he was involved in an accident, or for some other reason that caused that particular technician to leave work. When determination step 180 identifies that a change to a timeframe or time slot has occurred, program flow may move back to step 110 where timeframes and/or time slots are identified again.

When determination step 180 identifies that there are no changes to time slots or timeframes, program flow may move to step 150 where additional job data may be received. The flow chart of FIG. 1, thus illustrates a method that may be performed by an apparatus that tracks the current status of work for as few as one worker or as many workers as required. Because of this, the description is scalable well beyond the capabilities of a human using pen and paper. This means that the presently disclosed methods may be used to adjust the work flow of hundreds or thousands of workers dynamically as conditions change. Geographic areas managed by such systems may also scale from a small town, a cruise ship, to an entire region or country, for example.

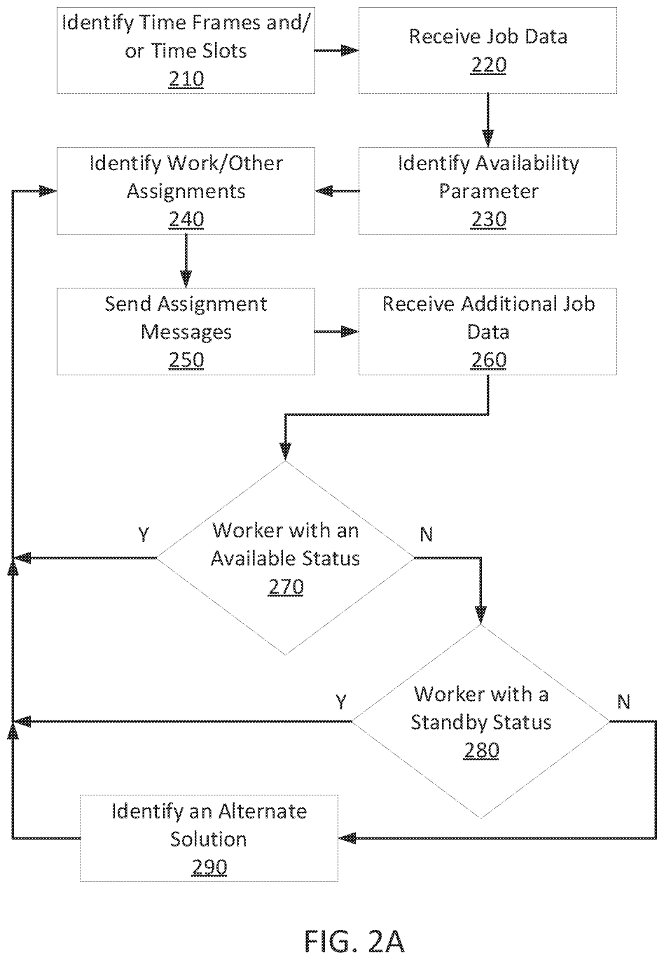

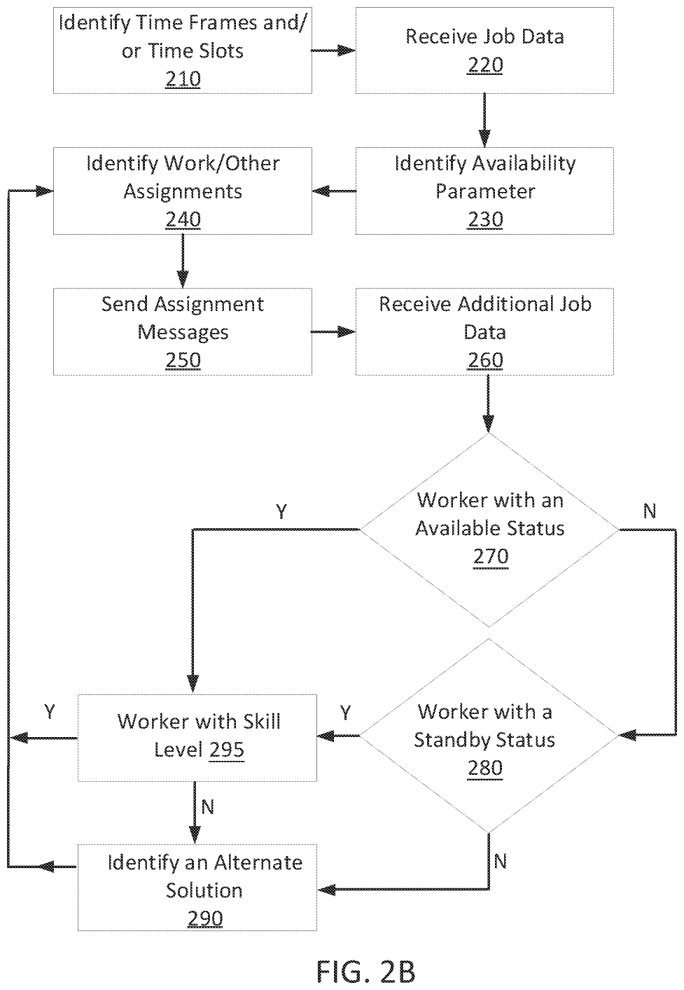

FIG. 2a illustrates a second set of steps that may be performed when work flow is controlled dynamically, here however, parameters may be used allow additional work assignments to be added at time when working demands are expected to change unexpectedly. Step 210 of FIG. 2 may, like step 110 of FIG. 1, identify timeframes and/or time slots. Here again time frames may correspond to time windows that customers expect a worker to arrive at their location and time slots may correspond to times that certain workers are available to work (or visa versa). Next, in step 220 of FIG. 2a job data may be received. Here again this job data may identify a type of job, a location, and a timeframe. After step 220, step 230 may identify an availability parameter. This availability parameter may correspond to an amount of time during a worker's time slot, when that worker will not be assigned a job. This amount of time may be classified as a “standby time,” where a worker is available to work just in case additional work needs to be performed or begun during a timeframe or time slot.

Next, in step 240, workers may be assigned jobs or be assigned other classifications. Assignments made in step 240 may be based on timeframes and job data, yet may also be made based on the availability parameter of step 230. In certain instances, each different worker may be assigned a different availability parameter. This may be based on seniority or may be based on a worker skill level or on any other basis desirable to an employer or the worker. The assignments identified in step 240 may include classifications of busy (assigned work), not assigned, standby, break, not available to work, or other, for example. An availability parameter may identify that a worker is available to be scheduled up to a percentage of the time he is able to work during a day. Workers may be assigned work until each worker is scheduled to work according to the availability parameter. When all workers are scheduled to work up to their respective availability parameter, workers may be assigned work during “standby” times. Such a process would provide a surge capacity as some technicians could be assigned to a standby status throughout the day.

In an instance when each technician is assigned an availability parameter of 20%, 20% of each technicians' available work hours could be reserved as standby time. Once each technician reaches an 80% of work time assignment (e.g. busy status) and additional jobs are received, an amount of a technician's standby time may be reduced by assigning that technician additional work. This process could continue until all technicians are 100% assigned to work specific jobs.

Alternatively, the availability percentage may identify a percentage of time that technicians should be assigned a working or busy status. In such an instance, an availability parameter of 80% may indicate that 20% of a workers shift should be reserved by the standby status until a surge capacity is required.

After step 240, assignment messages may be sent to worker devices in step 250. These assignments may be entered into a calendar at a user device, where a user of that user device may be allowed to parse the schedule and create messages associated with items included in their schedule or provide feedback regarding the status of a job.

After step 250, program flow may move to step 260 where additional job data may be received. Here again this received information may identify a new job and a new job location that needs to be scheduled. Determination step 270 may then identify whether a worker that has an available status during a timeframe associated with the new job. When determination step 270 identifies that a worker has available time, program flow may move to step 240 where work assignments are updated. When determination step 270 identifies that there is not a worker with an available status during the timeframe, program flow may move to determination step 280. Determination step 280 may then identify whether any worker has been assigned a standby status during the timeframe, when yes program flow may move to step 240 where work assignments may be updated.

When determination step 280 identifies that no workers are assigned the standby status during the timeframe, program flow may move to step 290, where an alternate solution is identified. The steps of FIG. 2 may occur in real-time or in near-real-time (e.g. at a time when a customer is on the phone or communicating actively with a service representative). In an instance, when all workers are busy, such as when all workers are assigned a status of busy, not available, or not on standby, a service representative may be prompted to ask the customer if the customers job may be scheduled at a different time. As such, an alternate solution may include scheduling a job to be performed on a different day or during a different time frame of a given day. After step 290, program flow may move back to step 240 where work assignments are once again updated.

Other status that may be associated with a job is a level of urgency or priority. Exemplary urgency or priority levels may include life system critical, urgent financial, high, medium, and low priority. A life system critical priority may relate to keeping a hospital operational after a system failure that threatens the ability of the hospital to provide needed medical services or may relate to an area where work needs to be performed to restore power or water services that otherwise could impair or threaten the health or welfare of people (e.g. gas leak, power outage at a shelter, or downed power lines). An urgent financial priority may be assigned to tasks that keep business districts operational after an event that disrupted utilities supplied to an affected business district. An urgent financial priority may also be assigned to broken water lines that affect property, yet that do not immediately threaten lives. A high priority may be assigned work relating to restoring power or water services at residences under conditions that are not associated with a life risk or property damage risk. A medium or low priority may be assigned to work affecting properties that are currently uninhabited or to general maintenance work. Under normal circumstances, such priority assignments may not be required or used and at these times, work may be assigned on a first come/first served or on a negotiated basis.

In an instance, where a customer has been assigned a timeframe for a technician to arrive and provide a service, yet some urgent or emergency condition arises, a service representative may be prompted to call the customer to reschedule their service call. In such instances, methods and systems consistent with the present disclosure may instruct the service representative to provide a reason for the rescheduling and may also inform the service representative to offer a discount or other compensation for the rescheduling event. Such capabilities will allow service providing companies with a way to service those most critically in need when a special circumstance arises while maintaining good customer satisfaction based on the company being socially responsible.

FIG. 2b illustrates an alternative set of steps that may be performed when work flow is controlled dynamically. As with the set of steps illustrating in FIG. 2a, parameters may be used to allow additional work assignments to be added at time when working demands are expected to change unexpectedly. Many of the steps illustrating by FIG. 2b are similar to the steps illustrated by FIG. 2a. For example, FIGS. 2a and 2b both illustrate the same steps 210, 220, 230 240, 250, 260, 270, and 280.

However, unlike FIG. 2a, FIG. 2b illustrates optional step 295. If it is determined at step 270 that at least one worker has an available status during a timeframe associated with the new job, program flow may move to step 295. Otherwise, program flow may move to step 280 where it is determined whether at least one worker has been assigned a standby status during the timeframe. If it is determined at step 280 that at least one worker has been assigned a standby status during the timeframe, program flow may move to step 295. Otherwise, program flow may move to step 290, where an alternate solution is identified. After step 290, program flow may move back to step 240 where work assignments are once again updated.

At step 295, it may be determined whether the at least one worker with the available status and/or the at least one worker that has been assigned a standby status has a necessary level of skill, attributes, and/or training to complete the new job. If the at least one worker with the available status and/or the at least one standby worker does not have the necessary level of skill, attributes, and/or training to complete the new job, then he or she is not truly “available” to complete the job (despite having time in his or her schedule to complete the new job).

In embodiments, a particular job can require more than one separate skill or attribute. For example, a job may require that a worker has a ladder (or some other piece of equipment or material) on his or her truck. Thus, the first “skill” required for this job may be having a ladder on the worker's truck. The same job may also require any number of additional skills, attributes, or level of training. At step 295, it may be determined whether the at least one worker with the available status and/or the at least one standby worker has each of the required skills. If the at least one worker with the available status and/or the at least one standby worker does not have all of the necessary level of skill, attributes, and/or training to complete the new job, then he or she is not truly “available” to complete the job (despite having time in his or her schedule to complete the new job).

If it is determined at step 295 that the at least one worker with the available status and/or the at least one standby worker does not have the necessary level of skill, attributes, and/or training to complete the new job, program flow program flow may move to step 290, where an alternate solution is identified. After step 290, program flow may move back to step 240 where work assignments are once again updated.

Table 1 illustrates an exemplary set of data that may be stored at a database. Table 1 includes three different timeframes, timeframe 1 (9 am-1 pm), timeframe 2 (1 pm-5 pm), and timeframe 3 (5 pm-9 pm). Table 1 also includes five different time slots for different technicians (Tech. A, Tech. B, Tech. C, Tech. D, and Tech. E). Note that each of the different technicians have been assigned different time slots, some of which are contiguous and some that are not. Because of this some technicians may work a split shift (e.g. Tech. A is assigned time slots 10 am-1 pm & 3 pm-6 pm), where others may work only for a contagious time slot (e.g. Tech. C is assigned a time slot that spans 9 am-2 pm). Each of the time slots illustrated in table 2 or each of a set of time slots for a particular worker may be referred to as a number of technician shifts. The number of technician shifts or available worker hours may be used to calculate work assignments according to methods consistent with the present disclosure.

Table 1 also includes other information that may identify a status associated with individual technicians at specific moments in time. Particular jobs included in table 1 are identified by a capital letter J and a job letter (A-F) separated by a hyphen (e.g. J-A, J-B, J-C, J-D, J-E, & J-F). Table 1 also identifies particular job locations using a capital letter L and a job location letter (A-F) separated by a hyphen (e.g. L-A, L-B, L-C, L-D, L-E, & L-F). Here J-A and L-A identify a first job A at a first location A. Table 1 also includes a standby status (StBy) and an available status (AV). A simple parsing of table 1, when displayed on a display, would allow a supervisor to see a current status of each of their employees and this supervisor could see which jobs had two different technicians working at a same job at a same moment in time. For example, Tech. A and Tech. C are both working at job Allocation A from 10 am to 11 am, where Tech. A began working at this same job at 9 am. Such scheduling could allow for more senior employees to supervise, inspect, or to train more junior employees.

The data of table 1 may also be accessible by a processor that executes instructions out of a memory when a computer evaluates or updates work schedules. This would allow for technicians with an available (AV) status or a standby (StBy) status to be assigned new jobs as those new jobs are received.

Table 2 illustrates some of the same data included in table 1, here however only the schedule of only a single technician is included. The data of table 2 may be sent to a mobile device of Tech. A so that technician may view the jobs that they have been assigned in a display of their mobile device. In certain instances, Tech. A may also be able to see information associated with other technicians, for example at time when they are scheduled to work with another technician at a point in time during the day.

Data stored at a scheduling database or provided to particular technician mobile devices may include additional data than the data illustrated in tables 1 and 2. For example, this data may identify a type of job, a street address, a customer phone number, an estimated transit time, and/or a time or time frame that a customer is expecting a service worker or service technician to arrive at the address.

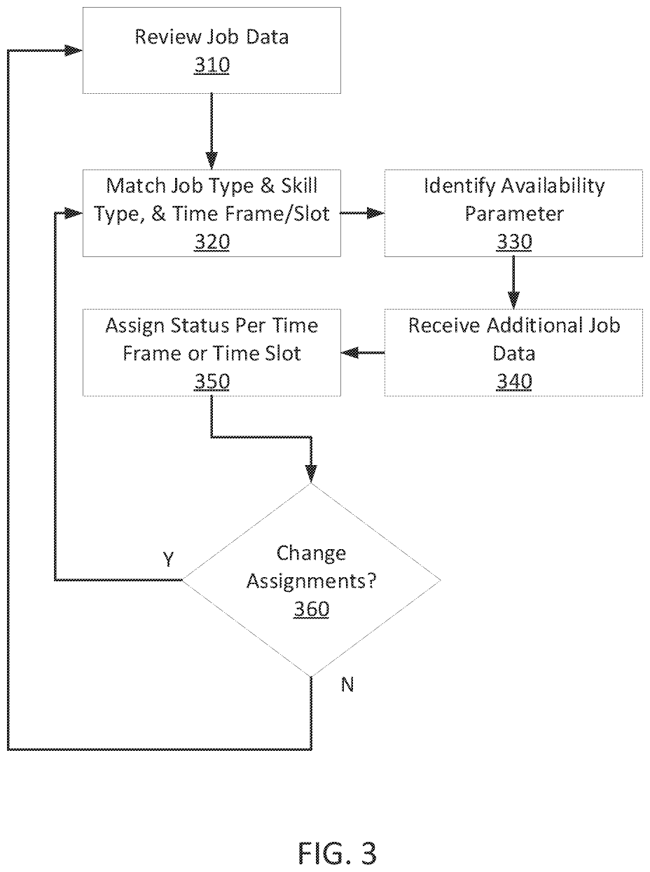

FIG. 3 illustrates a set of steps that may be performed when specific job types are matched to the skills of particular workers. FIG. 3 begins with step 310, where job data is reviewed. Step 320 may include identifying a type of job and matching that job to a skill of available technicians. For example, when a first available technician has the skills to clear a drain, that technician may be assigned a job to evaluate and work on clearing that drain. Step 320 may also include matching the job to a particular timeframe and a time slot when the first technician is available. After step 320, an availability parameter may be identified after which program flow may move to step 340 where additional job data is received. Then, based on an evaluation of available data, a status may be assigned to the first technician and possibly other technicians during certain timeframes or time slots in step 350.

Step 350 may assign Tech. B of table 1 a status of job D at location D (J-D*L-D), job E at location E (J-E*L-E), an available status (AV), or a standby status (StBy) at particular times during the day. At this same time, other technicians may also be assigned jobs or may be assigned new jobs. After step 350, program flow of FIG. 3 moves to determination step 360 that identifies whether assignments for various different technicians should be changed.

When determination step 360 identifies that assignments should be changed, program flow may move back to step 320, where job types, technician skill, and time frame/time slot data are matched such that different technicians' assignments may be updated. As mentioned above, technicians may be reassigned to different jobs for various reasons. When determination step identifies that assignments do not need to change, program flow may move back to step 310, where job data is reviewed again.

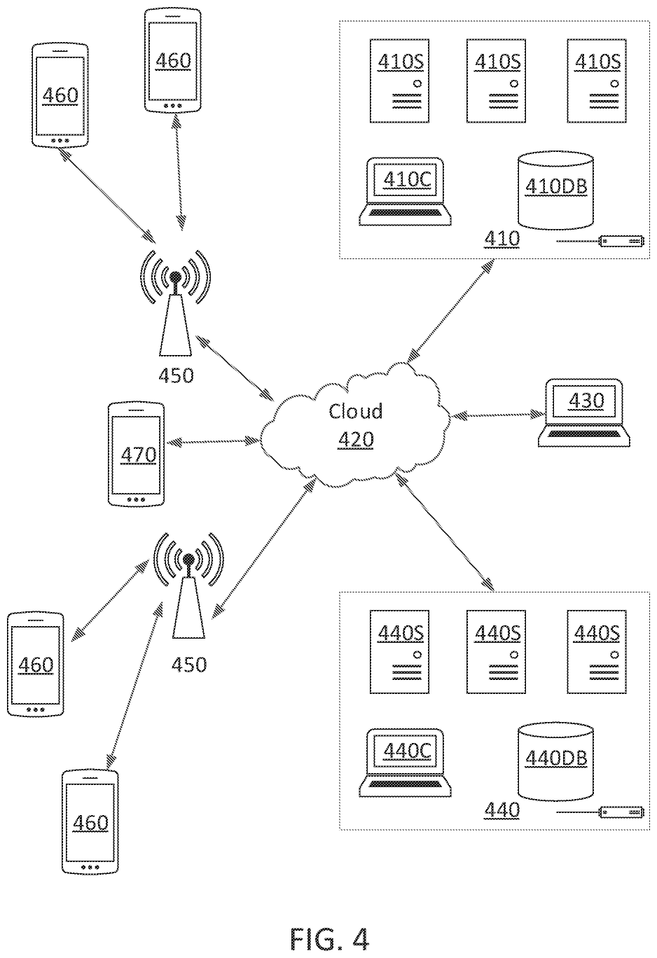

FIG. 4 illustrates a system that may perform the functions of receiving job information, identifying available technicians, making job assignments, and sending those assignments to technician mobile devices. FIG. 4 includes a work-flow capacity planning center 410, data collection system 440, cellular towers 450, technician user devices 460, computer 430, and phone 470. Each of these different devices may communicate with each other through the cloud or Internet 420.

Work-flow planning center 410 includes computer 410C, server(s) 410S, and a database 410DB. Data collection system 440 includes computer 440C, server(s) 440S, and a database 440DB. Computer 430 and phone 470 may be either a computer or phone owned by a customer or by a supervisor of a service providing company. A customer may use computer 430 or phone 470 to contact work-flow planning center 410, where computer 410C or server(s) 410S may access data stored at database 410DB when jobs are assigned to specific technicians. Whenever a customer arranges for a service call, the devices at work-flow planning center 410 may be used to perform the steps of FIGS. 1-3, discussed previously. Once the schedule of one or more technicians has/have been identified, messages may be sent to respective technician devices 460 via cloud/Internet 420 and cell towers 450 informing respective technicians of their schedule. Devices at or associated with work-flow planning center 410 may receive messages from a technician device whenever a particular technician meets a milestone (e.g. arrives at a job, begins work on a job, works longer than expected on a job, or completes a job). These messages may allow computer 410C to track work-flow of specific technicians and reassign work as necessary. In certain instances, a supervisor may track this work-flow via computer 430 of phone 470. A supervisor may also be allowed to provide data to computer 410C that may result in work assignments being modified. For example, a supervisor may change the availability parameter of FIG. 3 from 10% to an 20% availability. This supervisor may also be allowed to select certain specific technicians to be assigned certain specific jobs.

Data collection system 440 may include a set of computing devices that collect information that may affect the delivery of services to customers. For example, data collection system may be a system that tracks traffic or that collects data regarding emergencies or urgent conditions in region. Computing devices at work-flow planning center 410 may collect data from data collection system 440 from which transit time can be calculated or estimated. For example, when updating the scheduling of various technicians, computer 410C may communicate with computer 440C to collect traffic data. This traffic data may be used to identify that an accident will likely prevent a first service technician from being able to reach a particular customer in a scheduled time frame. Upon making this determination, computer 410C may identify an alternate technician that is available and that is located in an area that is not affected by the time delay caused by the accident. As such, systems and methods consistent with the present disclosure may collect information from other systems during the process of scheduling work-flows of particular technicians. Such capabilities may also allow for technicians or other personnel (e.g. emergency response—police—fire—ambulance) to be guided to a location to meet certain time constraints. Because of this, systems and methods consistent with the present disclosure may be expanded to be part of an overall emergency response system. Resources best available to perform or to assist in an emergency may be rescheduled considering data collected by emergency response data collection systems. For example, personnel may be dispatched to a gas leak caused by an earthquake via a route that does not require transport over a bridge damaged in the earthquake. Such a process may include accessing one or more databases, identifying the gas leak, identifying the damaged bridge, selecting a worker, identifying a route, and sending messages to identified worker devices.

Customers using computer 430 or phone 470 may also be provided with updates in real time or near real-time. This may allow messages to be sent directly from user devices 460 or indirectly via the work-flow capacity planning center 410 to devices owned by a customer. This may also allow customers to receive estimates for work or for additional work identified by a technician as soon as data associated with that work has been collected. In certain instances, data collected by technician devices may include images or video. For example, images of a leaking drain pipe under a house may be provided to a home owner device as or after they are collected by the technician crawling in a crawlspace. Here again these images or video may be passed directly from a technician device to a customer device or may be relayed through devices at the work-flow capacity planning center 410.

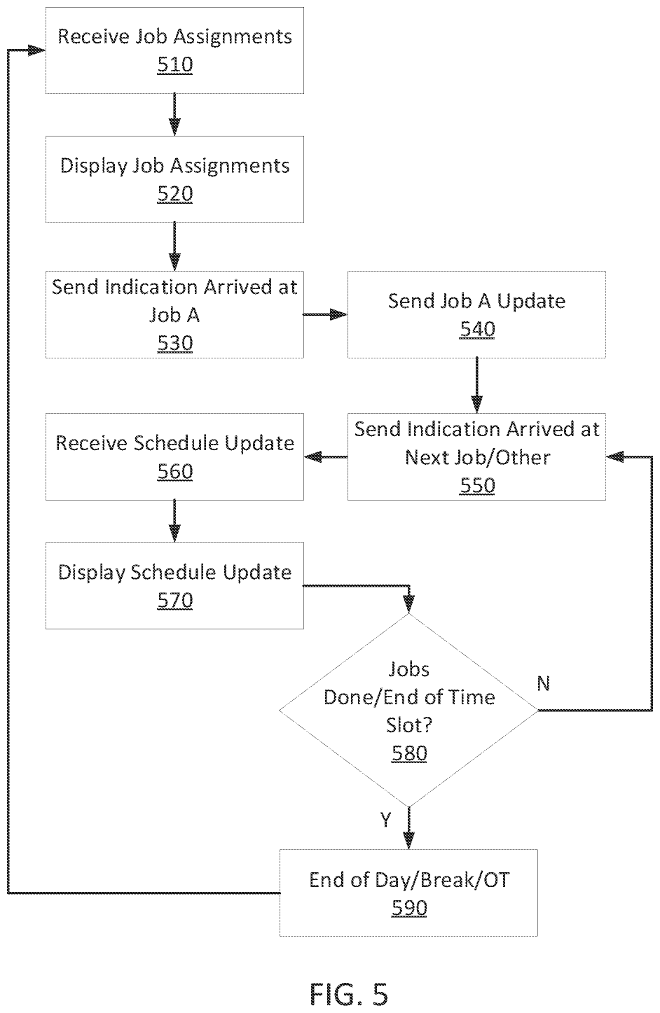

FIG. 5 illustrates steps that may be performed by a technician mobile device during a work day of a particular technician. The steps of FIG. 5 may be performed by technician devices 460 when these technician devices communicate with computer 410C of work-flow capacity planning center 410 of FIG. 4. Step 510 is a step where job assignments assigned to a first technician are received at the first technician's mobile device. Next, in step 520, the received assignments may be displayed on a display at the first technician's mobile device. The data displayed on the display may appear similar to the data contained in table 2 reviewed above. Additional data displayed on this display may include job addresses, a type of job, a customer phone number, and a timeframe that the customer expects the technician to arrive at the job. The technician device may also be configured to display mapping information and driving instructions to the job location.

Once the technician has arrived at a particular job (e.g. job A), a message may be sent from the technician device to devices at a work-flow capacity center in step 530. This message may be sent based on user entries made by the technician or may be sent automatically based on a determined location of the technician's mobile device. Such automatic messages may be sent based on locations identified by a global positioning system (GPS) at the technician device. Even instances when a technician sends an “arrived” message to the work-flow capacity center, this message may also include location information. This may allow devices at the work-flow capacity center to identify suspicious events. For example, in an instance where a technician steals a vehicle, is car jacked, or is kidnapped, a message indicating that the technician has arrived at a jobsite, when in fact the technician device has not arrived at the jobsite may be cause a corrective action to be performed. This corrective action may include calling the technician, dispatching additional personnel, or contacting the police.

After the technician has arrived at the jobsite and begun the job or completed the job, an update may be sent to computer 410C of work-flow capacity planning center 410 of FIG. 4 in step 540 of FIG. 5. Other types of update messages may be sent from a technician device, for example, a message may be sent indicating that the job will take additional time and that the technician will not be able to make it to a next job according to a current schedule. As mentioned above, this may be a condition that causes work-flows to be reevaluated and may cause job assignments to be changed.

After step 540, an indication may be sent from the technician device that indicates that the technician has arrived at a next or other job in step 550. Then, the technician device may receive an updated schedule in step 560, and that updated schedule may be displayed on the technician display in step 570 of FIG. 5. Program flow may then move to determination step 580 that may identify whether jobs assigned to the technician are complete or that a time slot associated with the technician has ended.

When determination step 580 identifies that that all of the technician's jobs have not been completed or that the technicians time slot has not ended, program flow may move back to step 550, where a message is sent from the technician device indicating that the technician has arrived at yet another next or other location. As mentioned above and not illustrated in FIG. 5 mapping data may be provided to a technician device as the technician drives to this next or other location. When determination step 580 identifies that a technician has completed all of his jobs or has reached an end of his time slot, program flow may move to step 590 where the technician may go home for the day (end of day), go on a break, or be allowed to work overtime (OT). After step 590, program flow may move to step 510 where additional job assignments are received. These additional assignments may be schedule during another time slot of the technician.

The operations performed in FIG. 5 may be performed according to functions programmed into an application program that may be downloaded onto particular user devices. These devices may be protected by a username and password or via some form of biometric locking mechanism. Messages sent from the user device may be generated when a technician selects certain specific selection boxes displayed in a graphical user interface (GUI) at a mobile device, or may be sent after the technician speaks certain keywords into a speaker of their mobile device. By making certain specific selections or by speaking certain keywords, time may be saved by the technician and an automated work-flow capacity planning center computer may be provided with a message that is easy for that computer to identify and act upon. Such functionality may allow a technician to interact with the computer of the work-flow capacity planning center in a “hands free” way, in a way that provides messages using a form of “short hand” notation, or both.

In such instances, a technician may simply say or select a message box to send a message. These short hand messages may identify various things, such as: “arrived at jobsite;” “begun job;” “extend job;” “job complete;” “driving to next job;” “delay;” “send help;” or “accident.” Any of these messages may cause updates to be made at the work-flow capacity planning center. These updates may in turn result in jobs being reevaluated and reassigned to other technicians or may result in a message being sent to a supervisor indicating that the supervisor should call the technician to collect additional details regarding a job or an event associated with the technician.

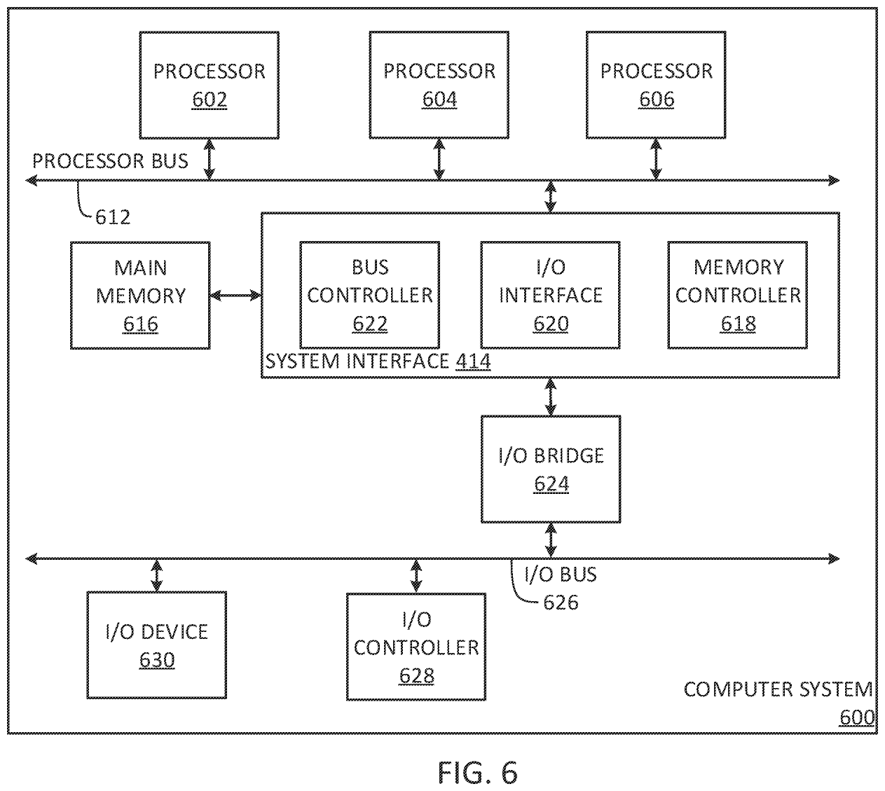

FIG. 6 is a block diagram illustrating an example of a computing device or computer system 600 which may be used in implementing the embodiments of the components of the network disclosed above. For example, the computing system 600 of FIG. 6 may be a work-flow capacity planning computer discussed above. The computer system (system) 600 includes one or more processors 602-606. Processors 602-606 may include one or more internal levels of cache (not shown) and a bus controller or bus interface unit to direct interaction with the processor bus 612. Processor bus 612, also known as the host bus or the front side bus, may be used to couple the processors 602-606 with the system interface 614. System interface 614 may be connected to the processor bus 612 to interface other components of the system 600 with the processor bus 612. For example, system interface 614 may include a memory controller 614 for interfacing a main memory 616 with the processor bus 612. The main memory 616 typically includes one or more memory cards and a control circuit (not shown). System interface 614 may also include an input/output (I/O) interface 620 to interface one or more I/O bridges or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

System 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. System 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computer system 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 616. Common forms of machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the description. For example, while the embodiments described above refer to particular features, the scope of this invention also includes embodiments having different combinations of features and embodiments that do not include all of the described features. Accordingly, the scope of the description is intended to embrace all such alternatives, modifications, and variations together with all equivalents thereof.

1. A computer-implemented method for capacity planning, the method comprising:
receiving, at a capacity planning system, data that identifies a first set of one or more time frames;
reviewing, at a capacity planning system, data that identifies a number of technician shifts;
receiving data that identifies a job;
assigning a first technician and a first time slot to perform the job, wherein the first technician and the first time slot are identified by:
performing a first comparison that compares the first set of one or more time frames with the data that identifies the number of technician shifts, and
identifying based on the first comparison that the first technician can perform the job during the first time slot; and
sending, by the capacity planning system, an assignment message to an electronic device associated with the first technician that identifies the job and the first time slot.

2. The method of claim 1, further comprising:
receiving, at a capacity planning system, an indication from the electronic device that the job has been performed within the first time slot;
identifying a second job to assign to the first technician during the first time slot based on an amount of time remaining in the first time slot; and
sending a second assignment message to the electronic device of the first technician that identifies the second job.

3. The method of claim 2, further comprising:
evaluating data that identifies a third job that has been assigned to the first technician during the first time slot;
identifying that the second job cannot be started by the first technician during the first time slot;
performing a second comparison that compares the first set of one or more time frames with the data that identifies the number of technician shifts;
identifying based on the second comparison that a second technician can perform the job during the first time slot; and
sending a third assignment message to an electronic device of the second technician that identifies the third job and the first time slot, wherein the second technician begins the third job based on the third assignment message being sent to the electronic device of the second technician.

4. The method of claim 1, further comprising:
receiving a parameter that adjusts an availability of one or more technicians during the first set of one or more time frames;
assigning at least one of a busy status, a standby status, or an available status to each of the one or more technicians during the first set of one or more time frames, wherein a second technician is assigned the standby status during a second time slot based on the received parameter;
receiving data identifying a second job and that the second job is scheduled to be begun during the second time slot;
identifying that none of the one or more technicians are assigned the available status during the second time slot; and
sending a second assignment message to an electronic device of a second technician based on the second technician being assigned the standby status during the second time slot.

5. The method of claim 4, further comprising adjusting the availability of the one or more technicians according to the parameter before assigning the at least one of the busy status, the standby status, or the available status to each of the one or more technicians.

6. The method of claim 5, wherein the parameter identifies a percentage of a time associated with the one or more time frames that the one or more technicians will be assigned the standby status.

7. The method of claim 4, further comprising:
identifying a beginning time of a first technician work shift, wherein the beginning time of the first technician work shift occurs within the first set of one or more time frames; and
identifying a beginning time of a second technician work shift, wherein the beginning time of the second technician work shift is different from the beginning time of the first technician work shift, and wherein the beginning time of the second technician work shift occurs within the first set of one or more time frames.

8. A non-transitory computer readable storage-medium having embodied thereon program instructions executable by a processor for implementing a method for capacity planning, the method comprising:
receiving, at a capacity planning system, data that identifies a first set of one or more time frames;
reviewing, at a capacity planning system, data that identifies a number of technician shifts;
receiving data that identifies a job;
assigning a first technician and a first time slot to perform the job, wherein the first technician and the first time slot are identified by:
performing a first comparison that compares the first set of one or more time frames with the data that identifies the number of technician shifts, and
identifying based on the first comparison that the first technician can perform the job during the first time slot; and
sending, by the capacity planning system, an assignment message to an electronic device associated with the first technician that identifies the job and the first time slot.

9. The non-transitory computer readable storage-medium of claim 8, the processor executing further instructions to:
evaluate an indication from the electronic device that the job has been performed within the first time slot;
identify a second job to assign to the first technician during the first time slot based on an amount of time remaining in the first time slot; and
prepare to send a second assignment message to the electronic device of the first technician that identifies the second job, wherein the second assignment message is sent to the electronic device of the first technician after the second assignment message is prepared.

10. The non-transitory computer readable storage-medium of claim 9, the processor executing further instructions to:
evaluate data that identifies a third job that has been assigned to the first technician during the first time slot;
identify that the second job cannot be started by the first technician during the first time slot;
perform a second comparison that compares the first set of one or more time frames with the data that identifies the number of technician shifts;
identify based on the second comparison that a second technician can perform the job during the first time slot; and
prepare to send a third assignment message to an electronic device of the second technician that identifies the third job and the first time slot, wherein the second technician begins the third job based on the third assignment message being sent to the electronic device of the second technician.

11. The non-transitory computer readable storage-medium of claim 9, the processor executing further instructions to:
adjust an availability of one or more technicians during the first set of one or more time frames based on a received parameter;
assign at least one of a busy status, a standby status, or an available status to each of the one or more technicians during the first set of one or more time frames, wherein a second technician is assigned the standby status during a second time slot based on the received parameter;
schedule a second job to be begun during the second time slot based on received data identifying the second job;
identify that none of the one or more technicians are assigned the available status during the second time slot; and
prepare a second assignment message to an electronic device of a second technician based on the second technician being assigned the standby status during the second time slot.

12. The non-transitory computer readable storage-medium of claim 11, the processor executing further instructions to adjust the availability of the one or more technicians according to the parameter before assigning the at least one of the busy status, the standby status, or the available status to each of the one or more technicians.

13. The non-transitory computer readable storage-medium of claim 1, wherein the parameter identifies a percentage of a time associated with the one or more time frames that the one or more technicians will be assigned the standby status.

14. The non-transitory computer readable storage-medium of claim 11, the processor executing further instructions to:
identify a beginning time of a first technician work shift, wherein the beginning time of the first technician work shift occurs within the first set of one or more time frames; and
identify a beginning time of a second technician work shift, wherein the beginning time of the second technician work shift is different from the beginning time of the first technician work shift, and wherein the beginning time of the second technician work shift occurs within the first set of one or more time frames.

15. A capacity planning apparatus that performs a method for capacity planning, the apparatus comprising:
a communication interface that receives data that identifies a first set of one or more time frames;
a memory; and
a processor that executes instructions out of the memory to:
review, at a capacity planning system, data that identifies a number of technician shifts,
review data that identifies a job,
assign a first technician and a first time slot to perform the job, wherein the first technician and the first time slot are identified by:
performing a first comparison that compares the first set of one or more time frames with the data that identifies the number of technician shifts, and
identifying based on the first comparison that the first technician can perform the job during the first time slot, wherein an assignment message is sent to an electronic device associated with the first technician that identifies the job and the first time slot via the communication interface.

16. The apparatus of claim 1, wherein:
the communication interface receives an indication from the electronic device that the job has been performed within the first time slot;
the processor executes further instructions out of the memory to identify a second job to assign to the first technician during the first time slot based on an amount of time remaining in the first time slot, and
the communication interface sends a second assignment message to the electronic device of the first technician that identifies the second job.

17. The method of claim 16, wherein:
the processor executes further instructions out of the memory to:
evaluate data that identifies a third job that has been assigned to the first technician during the first time slot,
identify that the second job cannot be started by the first technician during the first time slot,
perform a second comparison that compares the first set of one or more time frames with the data that identifies the number of technician shifts, and
identify based on the second comparison that a second technician can perform the job during the first time slot, and
a third assignment message is sent to an electronic device of the second technician via the communication interface, the third assignments message identifying the third job and the first time slot, wherein the second technician begins the third job based on the third assignment message being sent to the electronic device of the second technician.

18. The apparatus of claim 1, wherein:
a parameter that adjusts an availability of one or more technicians during the first set of one or more time frames is received;
and the processor executes further instructions out of the memory to:
assign at least one of a busy status, a standby status, or an available status to each of the one or more technicians during the first set of one or more time frames, wherein a second technician is assigned the standby status during a second time slot based on the received parameter,
evaluate data identifying a second job and that the second job is scheduled to be begun during the second time slot,
identify that none of the one or more technicians are assigned the available status during the second time slot, and
prepare to send a second assignment message to an electronic device of a second technician based on the second technician being assigned the standby status during the second time slot.

19. The apparatus of claim 18, wherein the processor executes further instructions out of the memory to adjust the availability of the one or more technicians according to the parameter before assigning the at least one of the busy status, the standby status, or the available status to each of the one or more technicians.

20. The apparatus of claim 5, wherein the parameter identifies a percentage of a time associated with the one or more time frames that the one or more technicians will be assigned the standby status.
